(19) United States
(12) Patent Application Publication
(10) Pub. No.: US 2003/0037138 A1
(43) Pub. Date: Feb. 20, 2003

(54) Method, apparatus, and program for identifying, restricting, and monitoring data sent from client computers

(75) Inventors: Michael Wayne Brown, Georgetown, TX (US); Rabindranath Dutta, Austin, TX (US); Michael A. Paolini, Austin, TX (US)

Correspondence Address: Duke W. Yee, Carstens, Yee & Cahoo, LLP, P.O. Box 802334, Dallas, TX, 75380, US

(73) Assignee: International Business Machines Corporation, Armonk, NY (US)

(21) Appl. No.: 09/931,300

(22) Filed: Aug. 16, 2001

(51) Int. Cl. G06F 15/16

(52) U.S. Cl. 709/225; 709/224; 709/229

(57) ABSTRACT

A monitoring tool operates just before packets are sent out from a client computer. The monitoring tool identifies the destination of data being sent and determines whether the destination is a trusted site. The monitoring tool may also check the data itself. If the data is unencrypted, the tool may perform a string or binary pattern search on the data. However, if the data is encrypted the monitoring tool may check for the amount of data being sent. The monitoring tool may then warn the user or an administrator if the data being sent appears to be uncharacteristically high. The monitoring tool may also take corrective action, such as blocking the transmission or disabling the offending program. Alternatively, the monitoring tool may attempt to alter the final destination of the data to the client computer itself. If the program still works, the program may continue to operate.

### BACKGROUND OF THE INVENTION

1. Technical Field

The present invention relates to network data processing systems and, in particular, to protecting against spyware. Still more particularly, the present invention provides a method, apparatus, and program for identifying, restricting, and monitoring data sent from client computers.

2. Description of Related Art

Spyware is software that executes on a client computer and sends information, such as Web surfing habits, to another site. Often built into free downloads from the Web, spyware transmits information in the background as the user moves around the Web. License agreements often say that the information is anonymous. Anonymous profiling means that usage habits are being recorded, but not the user individually. Software is typically used to create marketing profiles. For example, information gathered from spyware may indicate that people that visit Web site A often visit Web site B.

However, spyware may be more malicious as well. For example, a program that appears legitimate may perform some illicit activity when it is run. Such spyware, also referred to as a “trojan horse,” may be used to locate password information or other personal information, such as credit card numbers. A Trojan horse is similar to a virus, except that it does not replicate itself.

Current anti-spyware software acts as a cleanup utility. The anti-spyware software may come with a list of known spyware. The list may also be downloaded or updated. The software then searches the system for known spyware and allows the user to remove the offending software, if desired. However, this approach is only effective for known spyware. A system may still be vulnerable to spyware that has gone undetected and new spyware may be developed to avoid removal. Furthermore, if the spyware came attached to popular software, the offending program may be installed over and over.

Still further, some spyware software may not be undesirable. For example, a free music player may send usage habit information to its own site to taylor advertisements. Using the current anti-spyware software, a user may remove a favorite program because it was identified as spyware, not knowing the nature of the information being sent and to whom the information was sent.

Other prior art solutions perform a string search of data being sent from the system. For example, a filter may search for data that looks like credit card numbers. However, trojan software may bypass this form of security easily by encrypting the data. Another solution provides a program, such as a software firewall, that allows the user to designate which applications may send outgoing transmissions. Again, the user must make a decision as to whether to allow outgoing transmissions knowing only that the program attempts to send data.

Therefore, it would be advantageous to provide an improved mechanism for identifying, restricting, and monitoring data sent from client computers.

### SUMMARY OF THE INVENTION

The present invention provides a monitoring tool that operates just before packets are sent out from a client computer. The monitoring tool identifies the destination of data being sent and determines whether the destination is a trusted site. A list of trusted sites may be compiled by the user. The monitoring tool may also check the data itself. If the data is unencrypted, the tool may perform a string or pattern search on the data. However, if the data is encrypted the monitoring tool may check for the amount of data being sent. The monitoring tool may then warn the user or an administrator if the data begin sent appears to be uncharacteristically high.

The monitoring tool may also take corrective action, such as blocking the transmission or disabling the offending program. Alternatively, the monitoring tool may attempt to alter the final destination of the data to the client computer itself. If the functionality of the program is not affected by the altered destination, the program may continue to operate with the destination changed. If the functionality is affected by the altered destination, the monitoring tool may allow the user to disable the program. Thus, the user may limit outgoing transmissions to trusted sites. In case of damage from private information being released, the monitoring tool provides accountability, because data is sent only to those sites selected by the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram illustrating an example network configuration in accordance with a preferred embodiment of the present invention; and

FIG. 5 is a flowchart illustrating the operation of a monitoring tool in accordance with a preferred embodiment of the present invention.

### DETAILED DESCRIPTION OF THE PREFERRED EMBODIMENT

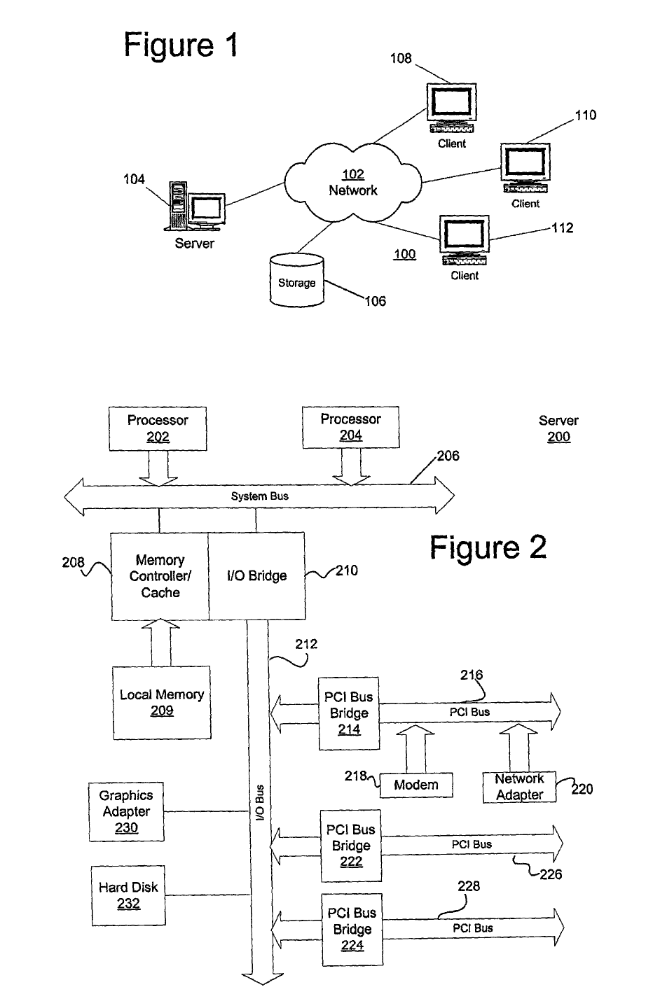

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

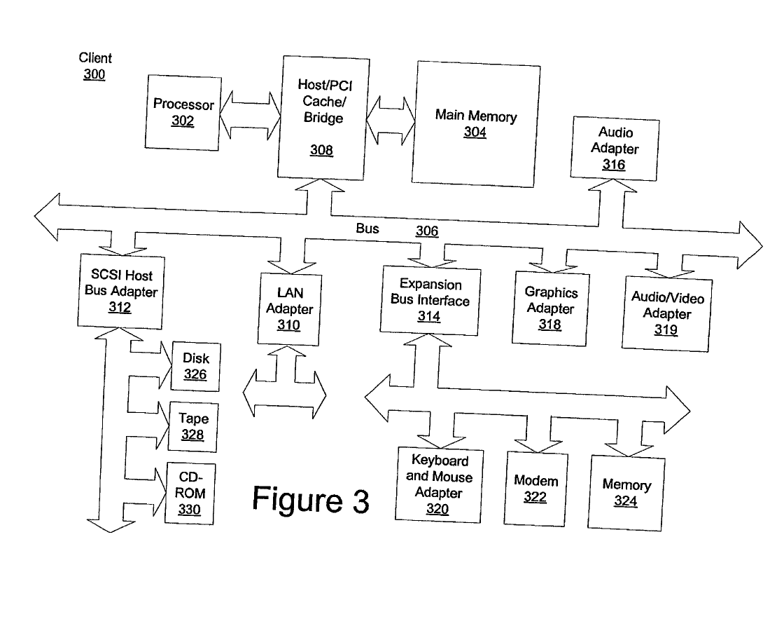

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Returning to FIG. 1, one of clients 108, 110, 112 may include spyware. For example, client 108 may download spyware from server 104 via network 102. Spyware may collect data on the client and transfer the data to a remote location, such as server 104. This data may include usage habits, such as Web usage information, or more damaging information, such as credit card numbers. In accordance with a preferred embodiment of the present invention, a monitoring tool is provided to protect the privacy of users.

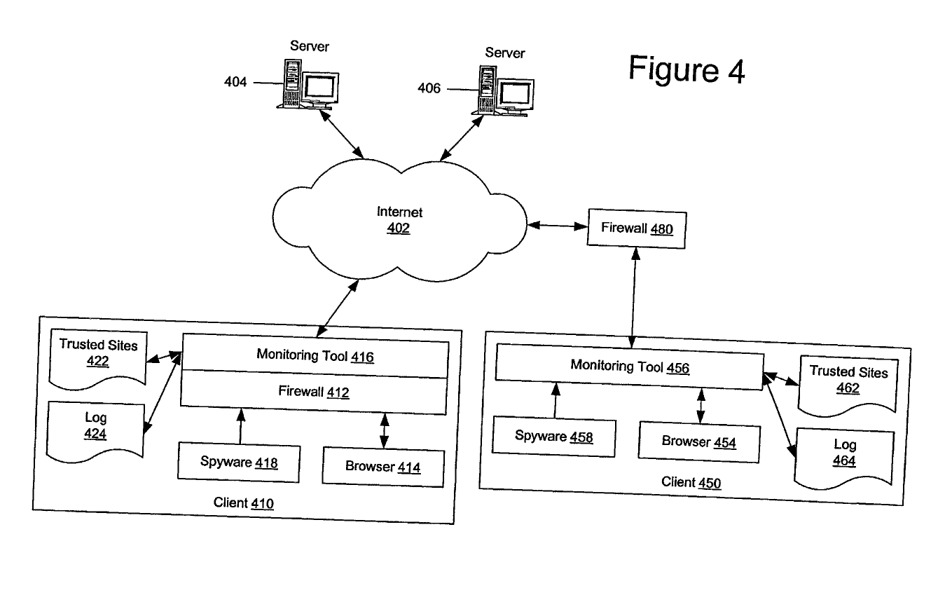

Turning now to FIG. 4, a block diagram illustrating an example network configuration is shown in accordance with a preferred embodiment of the present invention. Clients 410, 450 communicate with servers 404, 406 via Internet 402. Client 410 executes applications, such as browser 414, that communicate with the Internet through software firewall 412. Client 410 also executes spyware 418, which may be an application program, such as a media player, or a trojan program that runs in the background undetected. The software firewall may detect and block attacks originating outside the client. However, spyware 418 may initiate an outgoing transfer that is undetected by the software firewall.

Spyware 418 may transfer data to the site from which it was downloaded, such as server 404, or a third party site, such as server 406. For example, server 406 may belong to an enterprise that has agreed to pay for marketing data collected by the software provided by server 404. A user of client 410 may trust some sites with collected data, but may not trust other sites. For example, the user of client 410 may trust server 404, but not server 406.

In accordance with a preferred embodiment of the present invention, monitoring tool 416 operates just before packets are sent out from a client computer. A list of trusted sites 422, identified by Internet Protocol (IP) address, for example, is stored in the client. The user may compile the list of trusted sites as they are encountered. The monitoring tool identifies the destination of data being sent and determines whether the destination is a trusted site. The monitoring tool may also check the data itself. If the data is unencrypted, the tool may perform a string search or pattern search, such as for a binary pattern, on the data. However, if the data is encrypted the monitoring tool may check for the amount of data being sent. The monitoring tool may then warn the user or an administrator if the data being sent appears to be uncharacteristically high.

The monitoring tool may also take corrective action, such as blocking the transmission or disabling the offending program. Alternatively, monitoring tool 416 may attempt to alter the final destination of the data to the client computer itself. If the program still works, the program may continue to operate. Thus, the user may limit outgoing transmissions to trusted sites. In case of damage from private information being released, the monitoring tool provides accountability, because data is sent only to those sites selected by the user.

If the destination of an outgoing transmission is not a trusted site, the monitoring tool may prompt the user to add the site to the list of trusted sites or continue with the destination as an untrusted site. The monitoring tool may use a domain name server or “whois” lookup to display domain name information. Therefore, the user may identify sites as trusted or untrusted as they are encountered. Furthermore, whether a site is a trusted site may depend on the application program. Therefore, the user may indicate a destination as a trusted site for one application and an untrusted site for another application.

The monitoring tool may also attempt to encrypt some or all of the transmission and determine whether the program continues to operate correctly. Preferably, the data is encrypted in an irreversible manner, such as by injecting random numbers into the data. The recipient may be collecting the data for future examination without verifying the validity of the data at the time of transmission. By injecting garbage into the data, the monitoring tool may render the collected data effectively useless or at least very difficult to use. Thus, the user may continue to use the program while obscuring personal information in outgoing transmissions.

Corrective action may also include logging the attempted transfer to log 424. This information may be used to identify offending programs for removal or for awareness and accountability. For example, monitoring tool 416 may transfer the log to a server (not shown) associated with the provider of the monitoring tool or another entity, such as an administrator.

A complete log of all information sent may also be kept on a destination by destination basis. A separate log of all information sent may also be kept based on the originating program. This information may be kept for a session only or over the lifetime of the install of the system or program. Such a log may also be kept for both trusted and un-trusted destinations and programs. A log of all the information sent may prove useful even if the data is encrypted, because a decryption algorithm may become available at some point, allowing for the determination of the extent of damage done through the release of the information. A complete log also may give a decryption algorithm more to work with. In fact, such a log may help a company prove that it has or has not transmitted privileged information from its program.

Client 450 executes applications, such as browser 454. Client 450 may communicate with the Internet through hardware firewall 480. Client 450 also executes spyware 458, which may be an application program, such as a media player, or a trojan program that runs in the background undetected. The hardware firewall may detect and block attacks originating outside the client. However, spyware 458 may initiate an outgoing transfer that is undetected by the hardware firewall.

Monitoring tool 456 operates just before packets are sent out from a client computer. A list of trusted sites 462, identified by Internet Protocol (IP) address, for example, is stored in the client. Monitoring tool 456 may also log the attempted transfer to log 424.

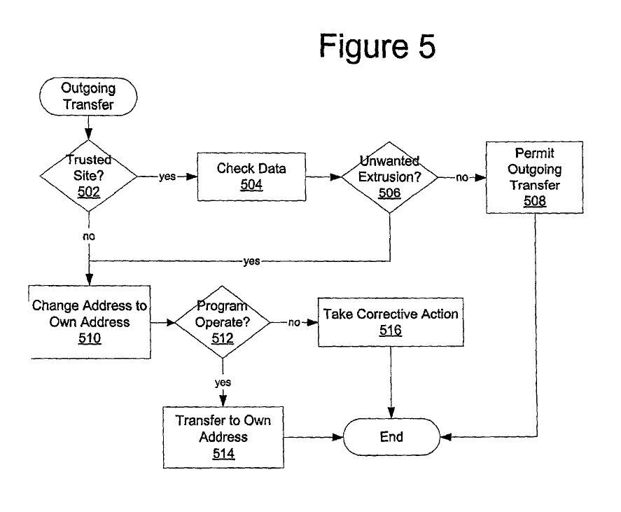

With reference now to FIG. 5, a flowchart is shown illustrating the operation of a monitoring tool in accordance with a preferred embodiment of the present invention. The process begins when an outgoing transfer is detected. A determination is made as to whether the destination of the outgoing transfer is a trusted site (step 502). If the destination is a trusted site, the process checks the data (step 504) and a determination is made as to whether the transfer is an unwanted extrusion (step 506). For example, the monitoring tool may perform a string search or pattern search, such as for a binary pattern, on the data if the data is unencrypted or check the amount of data being sent. Thus, an unwanted extrusion may be a transmission including personal data, such as credit card numbers, or a transmission for which the amount of data is uncharacteristically high. Whether the amount of data is uncharacteristically high may be predetermined or selected by the user.

If the transfer is not an unwanted extrusion, the process permits the outgoing transfer (step 508) and ends. If the transfer is an unwanted extrusion in step 506, the process changes the address for the transfer to the address of the client computer (step 510) and a determination is made as to whether the program still operates (step 512). Similarly, if the destination of the transfer is not a trusted site in step 502, the process alters the destination address and determines whether the program still operates. If the program operates, the process transfers the data to its own address (step 514) and ends. If the program does not operate in step 512, the process takes corrective action (step 516) and ends.

Corrective action may include actions, such as blocking the transfer or disabling the offending program. Furthermore, corrective action may include logging the attempted transfer. This information may be used to identify offending programs for removal or for awareness and accountability. Corrective action may also include prompting the user to determine whether to disable the offending program. For example, knowing the nature of the program, the user may consider the outgoing transfer to be necessary to the program's functionality and may decide to allow the program to send the data.

Thus, the present invention solves the disadvantages of the prior art by providing a monitoring tool that operates just before packets are sent out from a client computer. The monitoring tool identifies the destination of data being sent and determines whether the destination is a trusted site. Sites may be identified as trusted or untrusted as they are encountered based on the application. The monitoring tool may also check the data itself even if the data is encrypted. The monitoring tool may also take corrective action, such as blocking the transmission or disabling the offending program. Alternatively, the monitoring tool may attempt to alter the final destination of the data to the client computer itself and determine whether the program still functions properly. The monitoring tool may attempt to irreversibly encrypt the data to render the collected data useless. Thus, the user may limit outgoing transmissions to trusted sites. In case of damage from private information being released, the monitoring tool provides accountability, because data is sent only to those sites selected by the user.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a computer system, for monitoring data sent from a computer, comprising:
detecting a request for an outgoing transfer of data from a program in the computer system to a destination;
determining whether the destination is a trusted site; and
performing a corrective action if the destination is not a trusted site.

2. The method of claim 1, wherein the step of determining whether the destination is a trusted site comprises matching the destination against a list of trusted sites.

3. The method of claim 1, wherein the corrective action comprises blocking the outgoing transfer.

4. The method of claim 1, wherein the corrective action comprises disabling the program.

5. The method of claim 1, wherein the step of performing a corrective action comprises:
changing the destination of the outgoing transfer to the computer system; and
determining whether the program operates in response to the changed destination.

6. The method of claim 1, wherein the step of performing a corrective action comprises:
irreversibly encrypting the data; and
determining whether the program operates in response to the encryption.

7. The method of claim 6, wherein the step of irreversibly encrypting the data comprises injecting random numbers into the data.

8. The method of claim 1, further comprising:
determining whether the amount of data for the outgoing transfer is uncharacteristically high; and
performing a corrective action if the amount of data is uncharacteristically high.

9. The method of claim 1, further comprising:
determining whether the data includes personal information; and
performing a corrective action if the data includes personal information.

10. The method of claim 9, wherein the step of determining whether the data includes personal information comprises performing a text string search or binary pattern search on the data.

11. The method of claim 1, wherein the step of performing a corrective action comprises storing a log of the outgoing transfer.

12. The method of claim 11, wherein the step of storing a log of the outgoing transfer comprises storing the data.

13. The method of claim 11, further comprising transferring the log to a remote computer.

14. A method, in a computer system, for monitoring data sent from a computer, comprising:
detecting a request for an outgoing transfer of data from a program in the computer system to a destination;
determining whether the amount of the data is uncharacteristically high; and
performing a corrective action if the amount of the data is uncharacteristically high.

15. The method of claim 14, wherein the corrective action comprises blocking the data transfer.

16. The method of claim 14, wherein the corrective action comprises disabling the program.

17. The method of claim 14, wherein the step of performing a corrective action comprises:
changing the destination of the outgoing transfer to the computer system; and
determining whether the program operates in response to the changed destination.

18. The method of claim 14, wherein the step of performing a corrective action comprises:
irreversibly encrypting the data; and
determining whether the program operates in response to the encryption.

19. The method of claim 18, wherein the step of irreversibly encrypting the data comprises injecting random numbers into the data.

20. The method of claim 14, further comprising:
determining whether the data includes personal information; and
performing a corrective action if the data includes personal information.

21. The method of claim 20, wherein the step of determining whether the data includes personal information comprises performing a text string search or binary pattern search on the data.

22. The method of claim 14, wherein the step of performing a corrective action comprises storing a log of the outgoing transfer.

23. The method of claim 22, wherein the step of storing a log of the outgoing transfer comprises storing the data.

24. The method of claim 22, further comprising transferring the log to a remote computer.

25. An apparatus for monitoring data sent from a computer system, comprising:
detection means for detecting a request for an outgoing transfer of data from a program in the computer system to a destination;
determination means for determining whether the destination is a trusted site; and
correction means for performing a corrective action if the destination is not a trusted site.

26. The apparatus of claim 25, wherein the determination means comprises means for matching the destination against a list of trusted sites.

27. The apparatus of claim 25, wherein the corrective action comprises blocking the outgoing transfer.

28. The apparatus of claim 25, wherein the corrective action comprises disabling the program.

29. The apparatus of claim 25, wherein the correction means comprises:
means for changing the destination of the outgoing transfer to the computer system; and
means for determining whether the program operates in response to the changed destination.

30. The apparatus of claim 25, wherein the correction means comprises:
encryption means for irreversibly encrypting the data; and
means for determining whether the program operates in response to the encryption.

31. The apparatus of claim 30, wherein the encryption means comprises means for injecting random numbers into the data.

32. The apparatus of claim 25, further comprising:
means for determining whether the amount of data for the outgoing transfer is uncharacteristically high; and
means for performing a corrective action if the amount of data is uncharacteristically high.

33. The apparatus of claim 25, further comprising:
means for determining whether the data includes personal information; and
means for performing a corrective action if the data includes personal information.

34. The apparatus of claim 33, wherein the means for determining whether the data includes personal information comprises means for performing a text string search or binary pattern search on the data.

35. The apparatus of claim 25, wherein the step of performing a corrective action comprises storage means for storing a log the outgoing transfer.

36. The apparatus of claim 35, wherein the storage means comprises means for storing the data.

37. The apparatus of claim 35, further comprising means for transferring the log to a remote computer.

38. An apparatus for monitoring data sent from a computer system, comprising:
detection means for detecting a request for an outgoing transfer of data from a program in the computer system to a destination;
determination means for determining whether the amount of the data is uncharacteristically high; and
correction means for performing a corrective action if the amount of the data is uncharacteristically high.

39. The apparatus of claim 38, wherein the corrective action comprises blocking the data transfer.

40. The apparatus of claim 38, wherein the corrective action comprises disabling the program.

41. The apparatus of claim 38, wherein the correction means comprises:
means for changing the destination of the outgoing transfer to the computer system; and
means for determining whether the program operates in response to the changed destination.

42. The apparatus of claim 38, wherein the correction means comprises:
encryption means for irreversibly encrypting the data; and
means for determining whether the program operates in response to the encryption.

43. The apparatus of claim 42, wherein the encryption means comprises means for injecting random numbers into the data.

44. The apparatus of claim 38, further comprising:
means for determining whether the data includes personal information; and
means for performing a corrective action if the data includes personal information.

45. The apparatus of claim 44, wherein the means for determining whether the data includes personal information comprises means for performing a text string search or binary pattern search on the data.

46. The apparatus of claim 38, wherein the correction means comprises storage means for storing a log the outgoing transfer.

47. The apparatus of claim 48, wherein the storage means comprises means for storing the data.

48. The apparatus of claim 48, further comprising means for transferring the log to a remote computer.

49. A computer program product, in a computer readable medium, for monitoring data sent from a computer system, comprising:
instructions for detecting a request for an outgoing transfer of data from a program in the computer system to a destination;
instructions for determining whether the destination is a trusted site; and
instructions for performing a corrective action if the destination is not a trusted site.

50. A computer program product, in a computer readable medium, for monitoring data sent from a computer system, comprising:
instructions for detecting a request for an outgoing transfer of data from a program in the computer system to a destination;
instructions for determining whether the amount of the data is uncharacteristically high; and
instructions for performing a corrective action if the amount of the data is uncharacteristically high.
